(19) United States
(12) Patent Application Publication
(10) Pub. No.: US 2009/0319581 A1
(43) Pub. Date: Dec. 24, 2009

(54) Online Table Move

(75) Inventor: Jens Seifert, Gaertringen (DE)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/141,991

(22) Filed: Jun. 19, 2008

(51) Int. Cl. G06F 17/00

(52) U.S. Cl. 707/204; 707/E17.007

(57) ABSTRACT

A method of moving a table in a database management system includes: copying contents of a first table to a second table; monitoring operations performed on the first table during the copying; selectively storing changes performed on the first table to a temporary table based on the monitoring; and copying the changes from the temporary table to the second table.

### BACKGROUND

This disclosure relates to methods, systems, and computer program products for performing online table moves within a database.

Relational Database Management Systems (RDMS) often lack the capability to physically move tables inside the database. In addition, they lack the capability to change the characteristics of a table without taking the table offline. Taking a table “offline” means that all access requests relating to the table are prevented for the duration of the offline operation, for example, any read or write operations or both are not allowed. Applications accessing the database may be stalled until the table becomes online again. In some cases, the application may fail if the table is taken offline. Such performance is undesirable.

### SUMMARY

An exemplary embodiment of the invention includes a method of moving a table in a database management system including copying contents of a first table to a second table; monitoring operations performed on the first table during the copying; selectively storing changes performed on the first table to a temporary table based on the monitoring; and copying the changes from the temporary table to the second table.

A table management system, the system including a copy module that copies content of a first table to a second table; a replay module that selectively stores changes performed on the first table to a temporary table based on operations performed on the first table, and that copies the changes from the temporary table to the second table; and a swap module that associates properties of the first table with properties of the second table.

A computer program product that enables a computer to manage tables of a database management system, the computer program product including software instructions for enabling the computer to perform predetermined operations; and a computer readable medium bearing the software instructions; the predetermined operations including the steps of copying contents of a first table to a second table; monitoring operations performed on the first table during the copying; selectively storing changes performed on the first table to a temporary table based on the monitoring; and copying the changes from the temporary table to the second table.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings.

FIG. 1 is a block diagram illustrating a computing system that includes an online table moving system in accordance with an exemplary embodiment.

FIG. 2 is a dataflow diagram illustrating the online table moving system of FIG. 1 in accordance with an exemplary embodiment.

FIG. 3 illustrates exemplary tables of the online table moving system in accordance with an exemplary embodiment.

FIG. 4 is a flowchart illustrating an online table moving method that can be performed by the online table moving system of FIG. 2 in accordance with an exemplary embodiment

FIG. 5 is a flowchart illustrating a swap method of the online table moving method that can be performed by the online table moving system of FIG. 2 in accordance with an exemplary embodiment.

The detailed description explains the preferred embodiments of the invention, together with advantages and features, by way of example with reference to the drawings.

### DETAILED DESCRIPTION

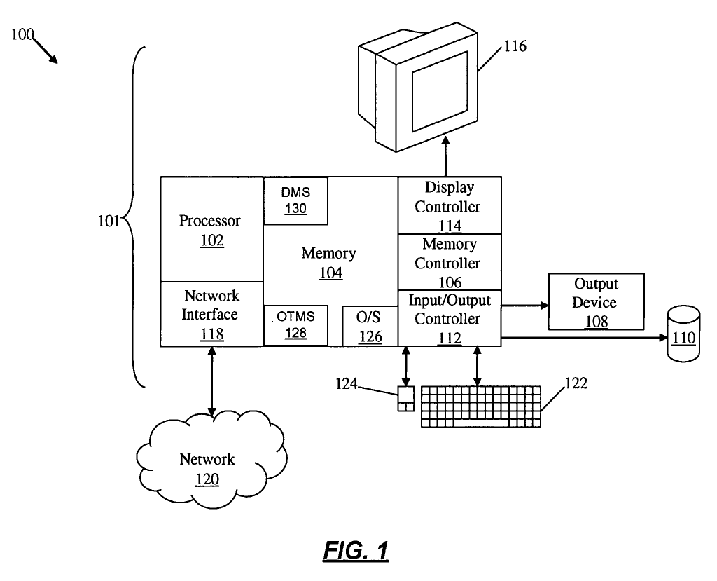

Turning now to FIG. 1, a block diagram illustrates an exemplary computing system 100 that includes an online table moving system (OTMS) 128 in accordance with the present disclosure. The computing system 100 is shown to include a computer 101. As can be appreciated, the computing system 100 can include any computing device, including but not limited to, a desktop computer, a laptop, a server, a portable handheld device, or any other electronic device. For ease of the discussion, the disclosure will be discussed in the context of the computer 101.

The computer 101 is shown to include a processor 102, memory 104 coupled to a memory controller 106, one or more input and/or output (I/O) devices 108, 110 (or peripherals) that are communicatively coupled via a local input/output controller 112, and a display controller 114 coupled to a display 116. In an exemplary embodiment, the system 100 can further include a network interface 118 for coupling to a network 120. The network 120 transmits and receives data between the computer 101 and external systems. In an exemplary embodiment, a conventional keyboard 122 and mouse 124 can be coupled to the input/output controller 112.

In various embodiments, the memory 104 stores instructions that can be executed by the processor 102. The instructions stored in memory 104 may include one or more separate programs, each of which comprises an ordered listing of executable instructions for implementing logical functions. In the example of FIG. 1, the instructions stored in the memory 104 include a suitable operating system (OS) 126. The operating system 126 essentially controls the execution of other computer programs and provides scheduling, input-output control, file and data management, memory management, and communication control and related services.

When the computer 101 is in operation, the processor 102 is configured to execute the instructions stored within the memory 104, to communicate data to and from the memory 104, and to generally control operations of the computer 101 pursuant to the instructions. The processor 102 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions.

The processor 102 executes the instructions of the online table moving system 128 of the present disclosure. In various embodiments, the online table moving system 128 of the present disclosure is stored in the memory 104 (as shown), is executed from a portable storage device (e.g., CD-ROM, Diskette, FlashDrive, etc.) (not shown), and/or is run from a remote location such as from a central server (not shown). The online table moving system 128 communicates with a database management system 130 to move the memory location or change properties of a table within a database of the database management system 130.

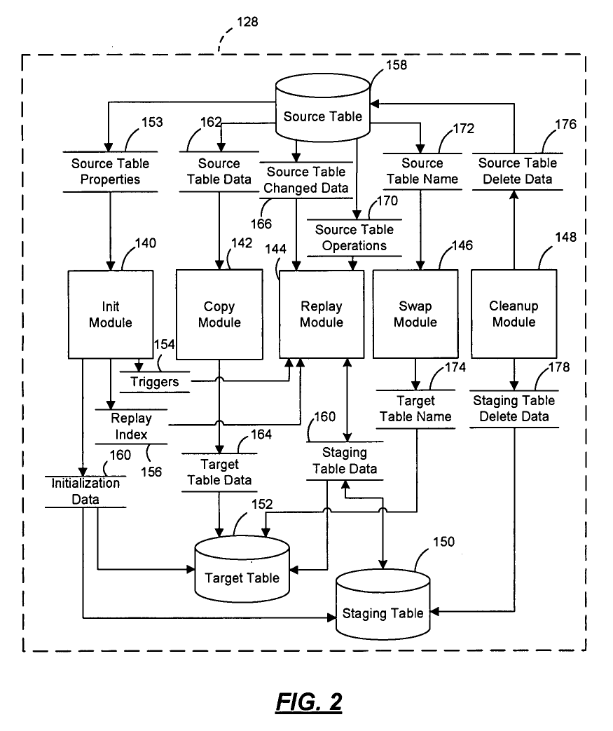

Turning now to FIG. 2, the online table moving system 128 is shown in accordance with an exemplary embodiment. The online table moving system 128 can include one or more modules and datastores. As can be appreciated, the modules can be implemented as software, hardware, firmware and/or other suitable components that provide the described functionality. As can be appreciated, the modules shown in FIG. 2 can be combined and/or further partitioned to similarly perform online table moves. In this example, the online table moving system 128 includes an initialization module 140, a copy module 142, a replay module 144, a swap module 146, and a cleanup module 148.

The initialization module 140 creates temporary objects that are used to perform the online table move. In various embodiments, the temporary objects include a staging table 150, a target table 152, one or more triggers 154, and a replay index 156. The initialization module 140 creates the staging table 150 and the target table 152 based on source table properties 153. In one example, the source table properties 153 can include a size, a dimension, and an index.

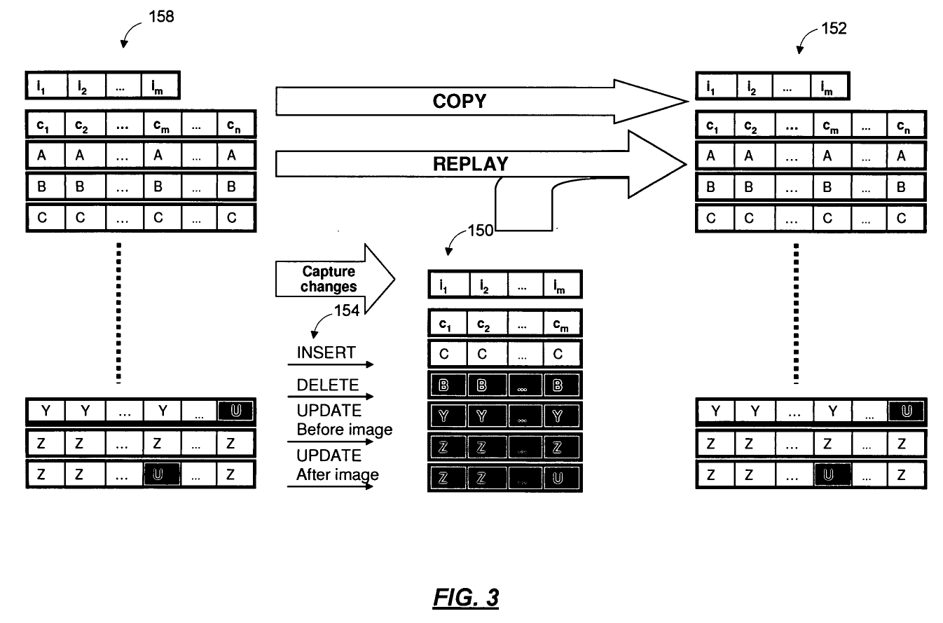

As shown in FIG. 3, the source table 158 is the original table to be moved. The source table 158 stores one or more records (A,B,C . . . ) by columns (c₁, c₂, . . . ). The columns can be accessed by an index (i₁, i₂, . . . ). The staging table 150 is used to capture changes that are performed on the source table 158. The staging table 150 stores changed records (e.g., U) according to the columns (c₁, c₂, . . . ) and the index (i₁, i₂). The target table 152 stores the content of the source table 158. The target table 152 can be defined similarly as the source table 158.

With reference back to FIG. 2, based on the source table properties 153, the initialization module 140 initializes the staging table 150 and the target table 152 via initialization data 160. In various embodiments, the target table 152 can be created according to a layout and/or physical location that are different than the source table 158. In one example, the creation of the target table 152 can be modified for example, to remove columns, to add new columns, to change the column order, to be created as range-partitioned or a multi-dimensional clustered (MDC) table, or to be converted back to a non range-partitioned table or a non-MDC table.

The initialization module 140 creates the triggers 154 to define when to capture changes on the source table 158. In one example, as shown in FIG. 3, the triggers 154 can be defined such that the changes are captured during the following events: insert, before an update, after an update, and delete.

With reference back to FIG. 2, to avoid naming conflicts with existing database objects, the initialization module 140 automatically creates the temporary objects using unique identifiers that conform to naming conventions of the database management system 130 (FIG. 1), but that are unlikely to already exist in the database management system 130 (FIG. 1). In one example, the initialization module 140 automatically names the temporary objects based on the following logic:

if the name of the source object is <source>,

then name temporary object: <source><hash key><suffix>.

The <hash key> is calculated from <source> using a hash method. In one example, the hash method creates an integer. The integer can be converted to a string using a modified mbase-64 method that uses valid characters according to the database management system 130 (FIG. 1). The <suffix> is added to identify the purpose of the object. In one example, the following suffixes can be used to identify the different tables: t=target object, s=staging object, and o=original object. In another example, the following suffixes can be used to identify the different triggers: i=insert trigger, u=before update trigger, v=after update trigger, and d=delete trigger. If the resulting name does not fit into the maximum allowed identifier length of the database management system 130 (FIG. 1), the <source> is shortened such that the resulting identifier is still a valid identifier. In various embodiments, a mapping table (not shown) can be used to keep track of the temporary objects.

In various embodiments, the initialization module 140 optionally initializes the replay index 156. The replay index 156 is used by the replay module 144 to enhance performance of the copy, as will be discussed in more detail below. In one example, the replay index 156 can be set to one of, a primary index, a smallest unique index, any non-unique index, and a generated index of the source table 158.

In one example, a primary index is a special unique index that is used typically for modeling a foreign key relationship in the database management system 130 (FIG. 1). A table can only have one primary index. Primary indexes cannot contain null values. Unique indexes enforce that only one row having the same key columns exist in a table. Non-unique indexes including MDC block indexes allow efficient access to rows of a table that match the same key columns, but don't guarantee uniqueness. If the table has no index at all, a non-unique index can be generated to allow efficient access during the replay phase of the online table move operation. This generated index is removed after the operation has been completed.

As can be appreciated the replay module 144 can maintain the staging table 150 without the existence of the indexes, however, the use of the indexes provide improved performance. If the source table 158 has no index, the “generated index” is created on the source table 158 and the target table 152. Otherwise only the index corresponding to the selected replay index 156 is created for the target table 152. As can be appreciated, the index of the staging table 150 is generated as a unique index, regardless of the selected replay index 156.

The copy module 142 copies source table data 162 of the source table 158 to target table data 164 and stores the target table data 164 in the target table 152. In one example, any committed row of the source table 158 is copied to the target table data 164. To provide maximal parallelism on the source table 158, the copy module 142 can copy the source table data 162 record by record.

In one example, the copy module copies the source table data 162 to the target table 152 using a cursor with hold shown by the following logic:

```
-- open a cursor on the source table
OPEN CURSOR WITH HOLD c AS SELECT c1, c2, c3 FROM <source>
WITH CS FOR READ ONLY
WHILE (true)
  -- fetch row from source table
  FETCH FROM c;
  -- if all records read from source table end loop
  IF SQLCODE == 100 THEN break;
  -- insert row fetch into target table
  INSERT INTO <target> (c1, c2, c3) VALUES (c.c1, c.c2, c.c3);
  -- increase row count
  row++;
  -- for better performance commit only every 10000 row
  IF row % 10000 == 0 THEN COMMIT;
END WHILE;
CLOSE CURSOR;
COMMIT;
```

In this example, the cursor is created with the following flags: WITH HOLD to avoid that the cursor closing if a COMMIT is issued; WITH CS to provide a cursor stability isolation level; and FOR READ ONLY to indicate to the database management systems 130 (FIG. 1) that no modification is planned and therefore other read operations do not need to wait if they read the same record as the COPY. As can be appreciated, the flags may be different for other database management systems (not shown).

For source tables 158 that implement a primary or unique index, the SELECT from the source table 158 is performed in a way that prevents a record from the source table 158 from being copied twice. This can be achieved by reading the records according to the primary or unique index. This can be achieved in the database management system 130 (FIG. 1) by giving the database management system 130 (FIG. 1) query optimizer hints to access the records over the index.

The replay module 144 maintains a copy of entries in the source table 158 that change while the copy module 142 is copying the source table data 162. In various embodiments, the replay module 144 stores source table change data 166 as staging table data 168 in the staging table 150 by evaluating source table operations 166 with the triggers 154.

For example, if the source table 158 has the columns c1 and c2 and an index i1 exists over c1, the initialization module 140 creates a staging table 150 with column c1 and a unique index over c1. When the source table operations 170 indicate that an insert operation is performed on the source table 158, the replay module 144 recognizes the insert operation based on the insert trigger 154 and creates an entry in the staging table 150. For example, provided the following insert operation, “INSERT of (c1, c2) with (1,‘A’) on source table,” an entry is created in staging table 150 as (c1)=(‘1’). It is possible that (‘1’) has been inserted by a previous operation, for example, DELETE or if the index i1 is not unique, it is possible that (‘1’) has been inserted by a previous INSERT operation. The unique index over the staging table 150 prevents the value (‘1’) from being inserted twice into the staging table 150.

When the source table operations 170 indicate that a delete operation is performed on the source table 158, the replay module 144 recognizes the delete operation based on the delete trigger 154, and creates an entry in the staging table 150. For example, provided the following delete operation, “DELETE of (c1, c2) with (1, ‘A’) on source table,” an entry is created in the staging table 150 as (c1)=(‘1’). It is possible that an entry of (‘1’) already exists in the staging table 150. Again the unique index on the staging table 150 prevents more than one of the same entries from being inserted into the staging table 150.

When the source table operations 170 indicate that an update operation is performed on the source table 158, the replay module 144 recognizes the replay operation based on the before update trigger 154 and the after update trigger 154. For example, provided the following update operation, “UPDATE of (‘1’, ‘A’) with (1,‘B’) on source table,” the replay module 144 recognizes this as an after update trigger. Only columns that are not part of the index i1 are modified. An entry in the staging table 150 with (‘1’) is created and again duplicates are ignored.

Provided the following update operation, “UPDATE of (‘1’,‘A’) with (2,‘A’) on source table,” the replay module 144 recognizes this as a before UPDATE trigger because there is a change in the key column. An entry with (‘1’) is created in the staging table 150. In addition the after UPDATE trigger is activated and an additional entry with (‘2’) is created.

For each source table operation 170 that generates a change (UPDATE, INSERT, DELETE) on the source table 158, an entry in the staging table 150 exists. Therefore, the contents of the staging table 150 reflect all changes on the source table 158. Because the changes are captured by logical addressing (tuples in the staging table 150) and not using any internal representation of rows (e.g., RIDs) the move is safe against RID changing operations (e.g., REORG or REDISTRIBUTE).

Once the changes are captured, the replay module 144 updates the target table 152 with the changes captured in the staging table 150. In one example, the replay module 144 copies the staging table data 168 stored in the staging table 150 to the target table 152 using the following logic:

```
OPEN CURSOR WITH HOLD c SELECT c1,c2 FROM <staging> WITH
CS FOR UPDATE
WHILE (true)
  FETCH c;
  -- if all records read from source table end loop
  IF SQLCODE == 100 THEN break;
  DELETE FROM <target> WHERE c1 = c.c1 AND c2 = c.c2;
  -- database specific: avoid waits on changes on source table to avoid
  deadlocks
  SET CURRENT LOCKTIMEOUT NOT WAIT;
  INSERT INTO <target> (c1, c2, c3) SELECT c1, c2, c3 FROM
  <source>
  WHERE c1 = c.c1 AND c2 = c.c2;
  -- database specific: return to normal lock wait behavior.
  SET CURRENT LOCKTIMEOUT WAIT;
  DELETE FROM <staging> WHERE CURRENT OF c;
  COMMIT;
END WHILE;
CLOSE c;
```

This exemplary logic avoids deadlocks and provides maximum parallelism on the source table 158. The additional “SET CURRENT LOCK TIMEOUT NOT WAIT” is used to prevent deadlocks. In this example, the replay module would face a lock timeout before the processing becomes a participant in a deadlock. This is a feature of DB2 for Linux, UNIX and Windows.

The swap module 146 adjusts the properties of the source table 158 and the target table 152 such that the database management system 130 (FIG. 1) now recognizes the target table 152 as the new source table. In one example, the swap module 146 renames the source table 158 via the source table name data 172 and gives the target table 152 the name of the source table 158 via the target table name data 174 and synchronizes any target table attributes (i.e., COMPRESS, VOLATILE, etc.) In order to facilitate the synchronization, the swap module 146 temporarily locks the source table 158 to avoid additional changes to be made to the source table 158 and hence, to be stored in the staging table 158.

The cleanup module 148 removes the source table 158 and the staging table 150 once the target table 152 is complete via source table delete data 176 and staging table delete data 178, respectively. The tables 150, 158 are removed after the lock is removed, to minimize the lock time.

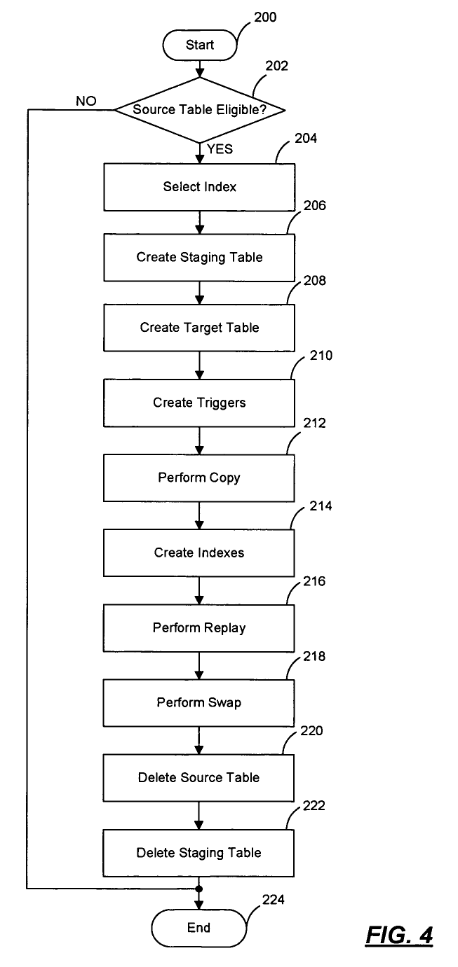

Turning now to FIG. 4, an online table moving method that can be performed by the online table moving system of FIG. 2 is shown in accordance with an exemplary embodiment. As can be appreciated in light of the disclosure, the order of operation within the method is not limited to the sequential execution as illustrated in FIG. 4, but may be performed in one or more varying orders as applicable and in accordance with the present disclosure.

In one example, the method may begin at 200. Properties of the source table are evaluated to determine if the source table is eligible to be moved at 202. If the source table is eligible to be moved at 202, the index is selected at block 204 and the temporary variables are created at blocks 206-210. Specifically, the staging table is created at block 206, the target table is created at block 208, and the triggers are created at block 210. Otherwise, if the source table is not eligible to be moved at 202, the method may end at 224.

Thereafter, the content of the source table is copied over to the target table at block 212. Indexes for the source table and the target table are created at block 214 and the replay is performed at block 216. As can be appreciated, the replay can be performed one or more times.

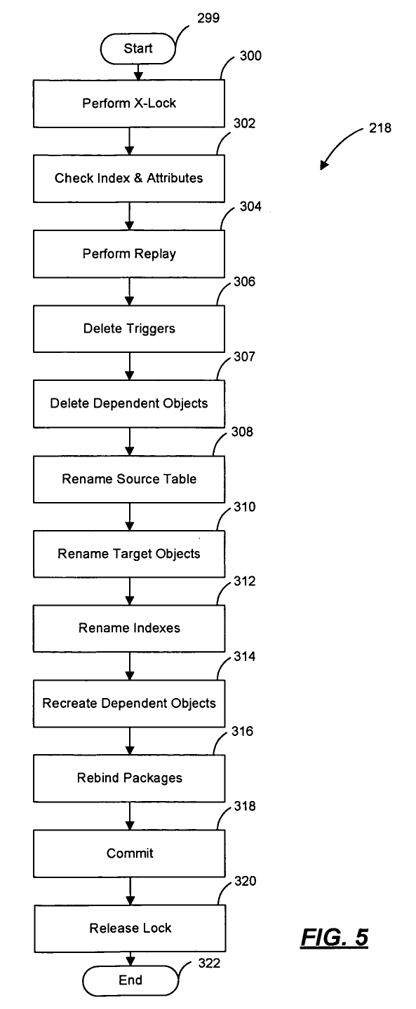

At blocks 218, the swap is performed. For example, as shown in FIG. 5, an exclusive lock (e.g., X-lock) is acquired on the source table to avoid any additional changes to be made to the source table at block 300. The table attributes or indexes are checked to see if they have not changed at block 302. The replay is performed once again at 304, but this time without intermediate COMMITs to allow the complete swap to finish.

At this point, the staging table is empty. The triggers that are used to capture the changes in the source table are deleted at block 306. The related objects (e.g., views, triggers, and routines) are deleted at block 307. The source table <source> is renamed to a temporary name <source><hash>o at block 308. The target table <source><hash>t is renamed to <source> at block 310.

For each index, the indexes <source index name> are renamed to <source index name><hash>o and the target indexes <source index name><hash>t are renamed to <source index name> at block 312. The related objects are recreated based on the new name at block 314. Any packages are rebound to refer to the new table at block 316 and a final COMMIT is performed at blocks 318. Now the target table is accessed by subsequent accesses to the source table. The lock is released at block 320, keeping the lock as short as possible to avoid long lock waits. As can be appreciated, if the transaction that starts with the lock fails, the whole transaction is rolled back and the swap can be performed again at a later time.

With reference back to FIG. 4, the move is complete, but the original objects still exist (suffix=o). Instead of renaming the original objects, the objects can be deleted. However, the delete operation is more expensive than a rename due to logging. Thus, at blocks 220, 222 of FIG. 4, the cleanup is performed. The source table is removed at block 220 and the staging table is removed at block 222. Thereafter, the method may end at 224.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of moving a table in a database management system, the method comprising:
copying contents of a first table to a second table;
monitoring operations performed on the first table during the copying;
selectively storing changes performed on the first table to a temporary table based on the monitoring; and
copying the changes from the temporary table to the second table.

2. The method of claim 1 wherein the monitoring operations is based on at least one of an update operation, a delete operation, and an insert operation.

3. The method of claim 2 further comprising identifying at least one of an update before operation and an update after operation based on the operations performed on the first table and wherein the selectively storing changes performed on the first table is based on the identifying.

4. The method of claim 1 wherein the selectively storing changes performed on the first table is based on an index of the first table.

5. The method of claim 4 further comprising associating an index with each change of the changes and wherein the selectively storing changes performed on the first table is based on a comparison of the indexes.

6. The method of claim 1 further comprising naming the second table based on a name of the first table.

7. The method of claim 1 further comprising naming at least one of the temporary table and the second table based on at least one of a hash function and an object identifier.

8. The method of claim 1 further comprising locking access to the first table during the copying of the changes from the temporary table to the second table.

9. A table management system, the system comprising:
a copy module that copies content of a first table to a second table;
a replay module that selectively stores changes performed on the first table to a temporary table based on operations performed on the first table, and that copies the changes from the temporary table to the second table; and
a swap module that associates properties of the first table with properties of the second table.

10. The system of claim 9 wherein the replay module further monitors the operations performed on the first table and selectively stores the changes based on the operations.

11. The system of claim 10 wherein the operations include at least one of an update operation, a delete operation, and an insert operation.

12. The system of claim 10 wherein the replay module identifies at least one of an update before operation and an update after operation based on the operations performed on the first table and wherein the selectively storing changes performed on the first table is based on the at least one of the update before operation and the update after operation.

13. The system of claim 9 wherein the replay module selectively stores the changes performed on the first table based on an index of the first table.

14. The system of claim 12 wherein the replay module associates an index with each change of the changes and wherein the replay module selectively stores the changes performed on the first table based on a comparison of the indexes.

15. The system of claim 9 further comprising naming the second table based on a name of the first table.

16. The system of claim 9 further comprising an initialization module that creates at least one of the temporary table and the second table and that names at least one of the temporary table and the second table based on at least one of a hash function and an object identifier.

17. The system of claim 9 wherein the swap module locks access to the first table during the copying of the changes from the temporary table to the second table.

18. The system of claim 9 further comprising a cleanup module that deletes the first table and the temporary table.

19. A computer program product that enables a computer to manage tables of a database management system, the computer program product comprising:
software instructions for enabling the computer to perform predetermined operations; and
a computer readable medium bearing the software instructions;
the predetermined operations including the steps of:
copying contents of a first table to a second table;
monitoring operations performed on the first table during the copying;
selectively storing changes performed on the first table to a temporary table based on the monitoring; and
copying the changes from the temporary table to the second table.
